(19) United States
(12) Patent Application Publication
(10) Pub. No.: US 2011/0089098 A1
(43) Pub. Date: Apr. 21, 2011

(54) BUOYANT WASTEWATER AERATION APPARATUS AND METHOD

(75) Inventors: Klaus E.T. Siebert, Pittsford, NY (US); David G. Long, Fairport, NY (US); James E. Donohue, Warsaw, NY (US)

(73) Assignee: FBC TECHNOLOGIES, INC., Leroy, NY (US)

(21) Appl. No.: 12/582,132

(22) Filed: Oct. 20, 2009

(51) Int. Cl. C02F 7/00; B23P 6/00

(52) U.S. Cl. 210/232; 210/242.2; 29/402.04

(57) ABSTRACT

A buoyant wastewater aeration apparatus includes a buoyant float pod and at least one air conduit leg removably attached at a leg input end to a respective air supply outlet. The float pod further includes a leg-retainer structure that accommodates efficient engagement/dis-engagement of the air conduit leg at a known region of the leg. The leg-retainer structure may be in the form of a resilient clamp having an open end for removably engaging the known region of the leg. Alternatively, the leg may have attached thereto in the known region thereof a leg retainer-engaging structure that surrounds the leg, wherein the leg-retainer structure is a non-resilient split-ring having a given shape and dimension. The split space has a dimension sufficient for the leg diameter to pass through. The leg-retainer structure and the leg retainer-engaging structure have complimentary shapes and dimensions that provide a removable, engagement of the leg retainer-engaging structure concentrically within the leg-retainer structure. When the leg retainer-engaging structure is concentrically engaged within the leg-retainer structure, the leg's air input end is connectably aligned with the air supply outlet. An associated method for servicing the apparatus without removing the apparatus from the working environment is disclosed.

### CROSS-REFERENCE TO RELATED APPLICATIONS

N/A.

### BACKGROUND OF THE INVENTION

1. Field of the Invention

Embodiments of the present invention relate to apparatus and methods for aerating (i.e., increasing the amount of oxygen in) wastewater; for example, in a wastewater lagoon. More particularly, embodiments of the invention are directed to a modular apparatus and associated methods that simplify and make more efficient the process of accessing and servicing submerged aeration system components in a working environment thereof.

2. Description of the Related Art

It is well known that certain kinds of waste can be treated by relatively long-term exposure to bacteria in a lagoon. Typically, the treatment of waste in lagoons occurs by both aerobic and anaerobic activity; that is, the treatment is by bacteria that require oxygen as well as bacteria that do not require oxygen to break down organic material in the lagoons. The byproducts of anaerobic bacteria include hydrogen sulfide and the like, which tend to have an unpleasant odor and may make the lagoons bad neighbors. Aerobic bacteria produce carbon dioxide as a byproduct and therefore can be situated in populated areas without creating noxious odors.

In many instances, the oxygen content in raw wastewater is sufficiently low to support only anaerobic bacterial activity. Various apparatus and methods are known to elevate the level of oxygen in the wastewater. In one method an aerator is floated on the surface of the lagoon. This floating or “surface” aerator acts as an agitator that causes a violent splashing of the water such that water at or just below the surface of the lagoon is ejected into the air. All of the splashing and ejection of the water increases the exposure of the water to air and aids in increasing the oxygen content of the water, thus enhancing the ability of the water to support aerobic bacterial activity. Surface aerators, however, are relatively inefficient in terms of the amount of oxygen they provide to the wastewater per unit of energy consumed. Also, the enhanced oxygen effects are transient in that the oxygen concentration in the wastewater returns to the non-aerated level almost immediately when surface aeration stops. The aerobic activity quickly ceases as anaerobic activity, with its associated problems, resumes.

Another wastewater aeration apparatus and method uses a bubble pipe to introduce air near the bottom of the lagoon. A bubble pipe is simply a horizontal pipe having a plurality of drilled holes. Air pumped into the pipe escapes through the holes and rises in streams of bubbles to the surface. The rising streams of bubbles act to increase the oxygen content in the immediate area. Bubble aeration suffers the same defect as surface aeration in that the effects of enhanced oxygenation are transient. The relatively large bubbles quickly rise to the surface and the elevated oxygen level quickly falls as soon as the pumping of air to the bubble pipe stops.

Several years ago, the instant applicant deployed a floating wastewater aeration system incorporating fine-bubble diffusers. Fine bubble diffusers generate streams of tiny bubbles of air as deep in the water as possible. The small bubbles slowly rise towards the surface as oxygen diffuses into the water. Oxygen transfer efficiency is directly related to the depth of the water through which the bubbles travel as they rise to the surface. Applicant's apparatus, called the O₂ctopus® floating fine bubble diffusion system, incorporated vertically disposed legs (e.g., 8) attached to a float pod surface component. A tubular membrane fine-bubble diffuser (e.g., Environmental Dynamics, Inc; Stanford Scientific) was disposed horizontally (i.e., at 90°) at the underwater distal end of each hollow-tube (air conduit) leg through which compressed air was supplied via a shore-based air supply to the float pod. The leg length was customized to the lagoon depth to locate the fine-bubble diffusers at the lowest possible depth to enhance oxygen transfer. A drawback of this system was that the system required lifting out of the water in order to access and service the fine-bubble diffusers. This typically required a boom truck and the related costs and time to operate.

The interested reader is directed to U.S. Pat. Nos. 6,344,144; 6,348,147; and 6,787,036, all of which are assigned to applicant, the subject matter of which is incorporated by reference herein in their entireties.

The inventors thus recognized a need for a simpler, more efficient apparatus and method to maintain the fine-bubble diffusers of the wastewater aeration system in its working environment; i.e., in a treatment lagoon. They further recognized the advantages and benefits of being able to perform such maintenance without the need to lift the floating aerator system out of the lagoon water. These and other advantages and benefits are achieved by the invention, which will be described in detail below and with reference to the drawings.

### BRIEF SUMMARY OF THE INVENTION

An embodiment of the invention is a buoyant wastewater aeration apparatus for use in a wastewater treatment lagoon. The wastewater aeration apparatus includes a buoyant float pod including a float pod body having an air supply inlet and at least one air supply outlet, a plurality of first support members connected to and extending downward from the float pod body, a horizontally-oriented support member connected to a distal end of each of the plurality of the first support members; and at least one leg-retainer structure connected to the horizontally-oriented support member; at least one air conduit leg removably attached at a leg input end to a respective one of the at least one air supply outlet and having an air-outlet end, wherein the at least one air conduit leg has a known region at a fixed distance from the leg input end that is between the leg's air input end and the air-outlet end, wherein the leg is removably engaged with a respective leg-retaining structure. In a non-limiting aspect, the leg-retainer structure is a resilient clamp having an open end for removably engaging the known region of the leg. In another non-limiting aspect, the at least one air conduit leg has attached thereto in the known region thereof a leg retainer-engaging structure that surrounds the leg, wherein the leg-retainer structure is a non-resilient split-ring having a given shape, dimension, and orientation sufficient for the leg diameter to pass through. The leg-retainer structure and the leg retainer-engaging structure have complimentary shapes and dimensions that provide a removable, engagement of the leg retainer-engaging structure concentrically within the leg-retainer structure. When the leg retainer-engaging structure is concentrically engaged within the leg-retainer structure, the leg's air input end is connectably aligned with the respective air supply outlet on the float pod. In various non-limiting aspects, the apparatus may include 1 to N air conduit legs and associated air outlet connections and leg retainer structures; typically N=4 to 8, but the invention is not so limited. According to a non-limiting aspect, the at least one air conduit leg may be extendable between the known region where it attaches to the leg retainer structure and the air-outlet end of the leg. In a non-limiting aspect, the apparatus includes one or more counterweights for buoyancy control.

Another embodiment of the invention is a method for servicing a portable wastewater aeration apparatus without removing the apparatus from a working environment thereof, e.g., a wastewater treatment lagoon. The method involves the steps of dispatching a person in a surface vessel to the floating wastewater aeration apparatus in the wastewater treatment lagoon, wherein the floating wastewater aeration apparatus includes a float pod body on the surface of the wastewater treatment lagoon and at least one air conduit leg having a leg input end attached to a respective air supply outlet on the float pod body and having an air-outlet end connected to a submerged bubble diffuser near the bottom of the lagoon; from the surface vessel, detaching the input end of the at least one air conduit leg from the respective air supply outlet and disengaging a submerged known region of the at least one air conduit leg from a submerged leg retainer structure attached to a support structure of the apparatus; and removing the at least one air conduit leg from the wastewater treatment lagoon. The method may further include the steps of servicing the bubble diffuser in the surface vessel; re-engaging the at least one air conduit leg with the submerged support structure from the surface vessel; and re-attaching the input end of the at least one air conduit leg from the respective air supply from the surface vessel.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

The present invention will be more fully understood and appreciated by reading the following Detailed Description in conjunction with the accompanying drawings, in which:

FIG. 1 is a schematic front elevational view of a wastewater aeration apparatus for use in a wastewater treatment lagoon, according to a non-limiting illustrative embodiment of the invention;

FIG. 2 is a schematic top plan view of a wastewater aeration apparatus for use in a wastewater treatment lagoon, according to a non-limiting illustrative embodiment of the invention;

FIG. 3 is a schematic front sectional view of a wastewater aeration apparatus showing a leg-retainer structure according to a non-limiting illustrative aspect of the invention;

FIG. 4 is a schematic top cross sectional view of a wastewater aeration apparatus showing a leg-retainer structure and a leg retainer-engaging structure according to a non-limiting illustrative aspect of the invention;

FIG. 5 is a schematic perspective view of the leg-retainer structure and the leg retainer-engaging structure illustrated in FIG. 4, according to a non-limiting aspect of the invention;

FIG. 6 is a schematic top cross sectional view of a leg-retainer structure and a leg retainer-engaging structure according to a different, non-limiting illustrative aspect of the invention;

FIG. 7 is a schematic top plan view of a leg retainer-engaging structure according to a non-limiting illustrative aspect of the invention;

FIG. 8 is a schematic top cross sectional view of a leg retainer-engaging structure according to a different, non-limiting illustrative aspect of the invention;

FIG. 9 is a schematic top cross sectional view of a leg retainer-engaging structure according to a different, non-limiting illustrative aspect of the invention; and

FIG. 10 is a schematic perspective view of a wastewater aeration apparatus having an attached bio-media, in a working environment, according to an illustrative embodiment of the invention.

### DETAILED DESCRIPTION OF THE EMBODIMENTS OF THE INVENTION

Reference will now be made in detail to the present exemplary embodiments of the invention, examples of which are illustrated in the accompanying drawings. Wherever possible, the same reference numbers will be used throughout the drawings to refer to the same or like parts.

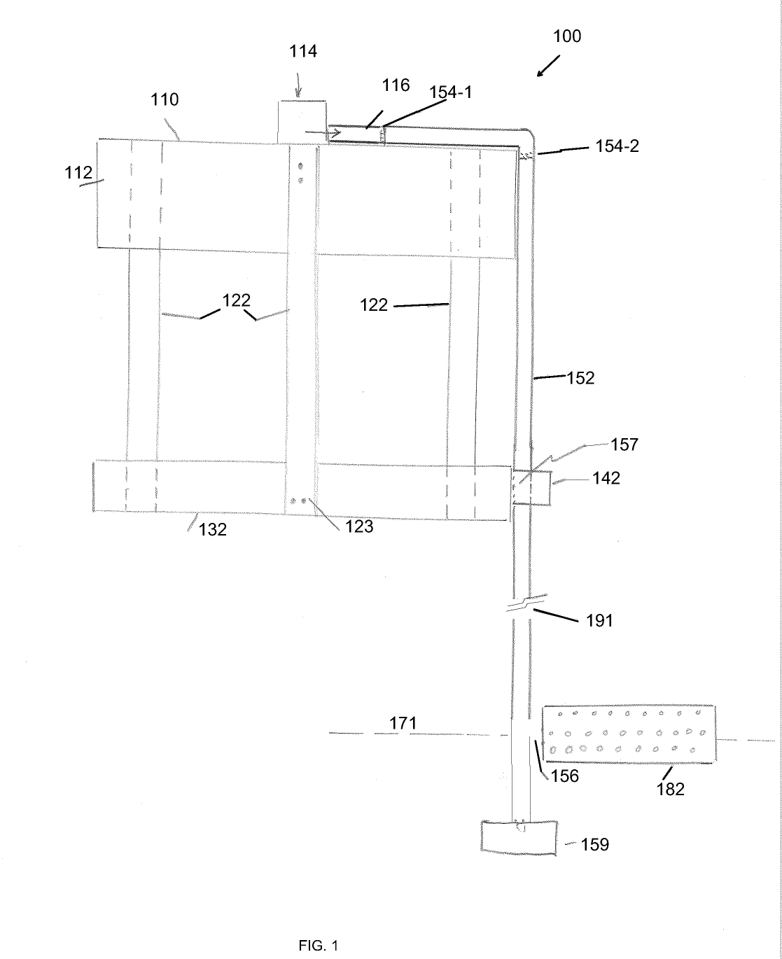

An embodiment of a wastewater aeration apparatus 100 for use in a wastewater treatment lagoon is illustrated in FIG. 1. The apparatus includes a buoyant float pod 110 comprising a float pod body 112 having an air supply inlet 114 and at least one air supply outlet 116, a plurality of first support members 122 connected to and extending downward from the float pod body, a horizontally-oriented support member 132 connected at a distal end 123 of each of the plurality of the first support members; and at least one leg-retainer structure 142 connected to the horizontally-oriented support member. The apparatus further includes at least one air conduit leg 152 removably attached at a leg air input end 154 to a respective air supply outlet at an air-outlet end 156. The at least one air conduit leg 152 has a known region shown at 157 that is at a fixed distance from the leg input end and intermediate the leg input end and the air-outlet end, where the leg can be engaged/disengaged with a respective leg-retainer structure 142. One or more counterweights may also be attached to the apparatus. As shown in FIG. 1, a counterweight 159 is connected to the distal end of the air conduit leg 152. The position of the counterweight can be adjusted so that it sits on the bottom of the lagoon to stabilize the apparatus. The number of counterweights can be selected relative to the number of legs and their placement relative to the float pod.

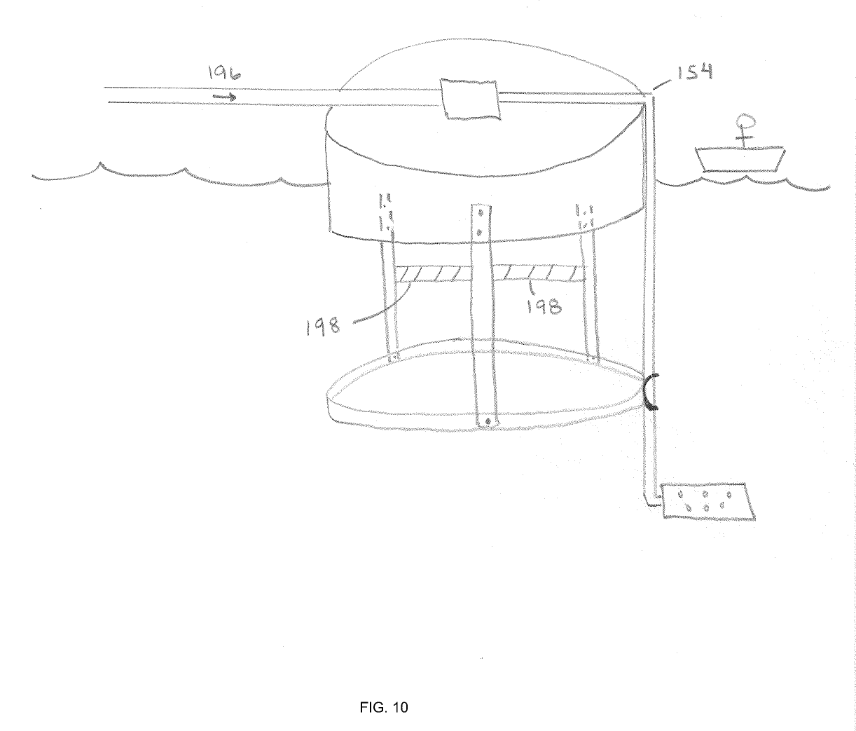

The buoyant float pod 110 may advantageously be constructed of stainless steel to resist corrosion in a wastewater treatment lagoon or other typical working environment. The float pod body 112 may be a hollow structure that is filled with a material such as, e.g., Styrofoam™ Buoyancy Billets available from Dow. The air supply inlet 114 is connected to a hose 196 (FIG. 10) that in turn is connected to an air generator (not shown) located on land. The at least one air supply outlet 116 will detachably couple to a respective air conduit leg as further described below; however, it is noted that the coupling point may be along the top of the float body as shown at 154-1 or may be located along the side of the float body as shown at 154-2.

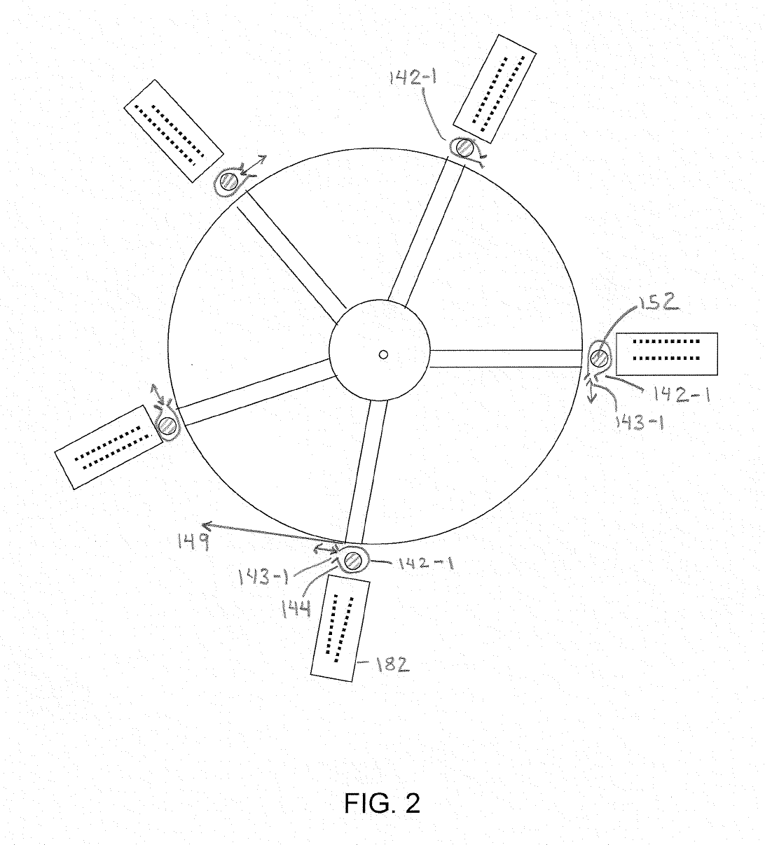

The first support members 122 of the float pod are shown extending vertically downward from the pod body and connected at their lower (distal) ends to the horizontally-oriented support member 132 as shown in FIG. 1. In a working environment, the float pod body will substantially float on the water's surface at least so that the air supply connections 114, 154 are above the water level. Based on the depth of an exemplary municipal wastewater treatment lagoon, the horizontal support member will be at a nominal water depth of four to six feet. The shape of the apparatus may be round as illustrated in FIG. 2, however square or other geometric shapes may be used to most conveniently optimize the number and positioning of multiple air conduit legs and bubble diffusers.

As further shown in FIG. 1, the at least one air conduit leg is connected at an air inlet end 154 thereof to the air supply. The leg extends vertically downward into the water and has an air outlet end 156 where it is typically connected to a fine bubble diffuser 182 near the bottom of the lagoon. A coarse bubble diffuser could be used in place of the fine bubble diffuser. Depending upon the distance of the horizontal support member relative to the pod body, there will be a known region 157 of the leg at a fixed distance from the air coupling connection 154 where the leg is engageable/disengageable with a leg retainer structure 142, which itself is attached to the horizontal support member. The leg may be fitted with a coupling as shown at 191 between the known region and the outlet end to adjust the leg length for a given working environment depth.

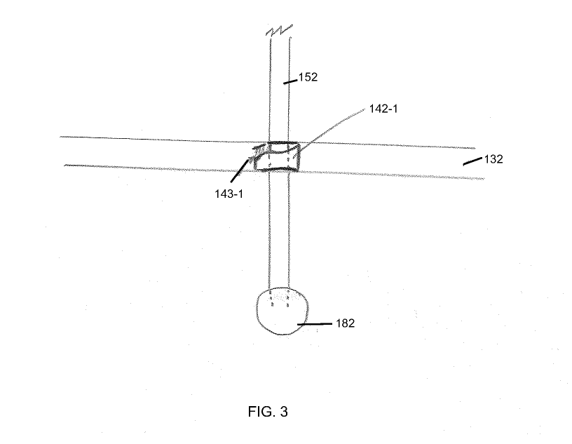

In a non-limiting aspect, the leg retainer structure is in the form of a resilient clamp 142-1 having an open mouth 143-1 as shown in FIGS. 2 and 3. The air conduit leg may have a nominal diameter of one to two inches, so the clamp opening will be sized accordingly. The clamp may have a detent region as shown at 144 in FIG. 2 where the leg settles once engaged. As further shown in FIG. 2 and in a non-limiting aspect, the leg retainer structure is attached to the horizontal support member in a manner that orients the opening 143-1 in a direction 149 that is generally tangent to the surface of the horizontal support member. An advantage of this orientation is that it may make it easier to engage the leg with the leg retainer structure in the working environment while also helping to orient the bubble diffuser(s) in a preferred direction that is normal to the apparatus at the connecting locations, as illustrated in FIG. 2.

Thus in a working environment, a person in a surface vessel (FIG. 10) can de-couple an air conduit leg from the air supply at 154, disengage the leg from the leg retainer structure, and remove the leg and attached bubble diffuser from the water; service the bubble diffuser, return the leg/diffuser assembly to the water, engage the known region of the leg with the leg retainer structure, and re-couple the leg air input to the air supply. Since the known region of the leg is predetermined, once engaged with the leg retainer structure the leg air inlet and the air supply outlet will be in alignment for connection. Advantageously, this process can be performed without removing the apparatus 100 from the working environment.

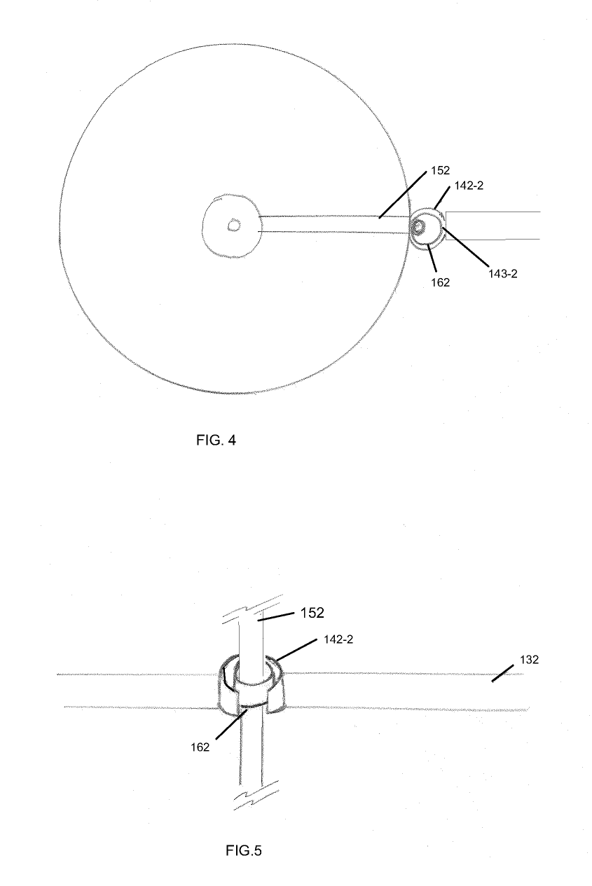

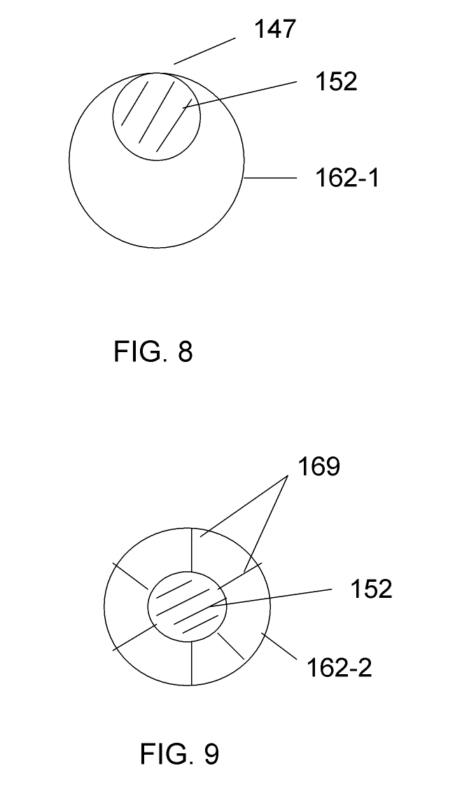

FIGS. 4, 5, 8, 9 illustrate another non-limiting aspect of a leg retainer structure 142-2 and a complimentary leg retainer-engaging structure 162. A leg retainer-engaging structure 162-1 is shown in the form of a solid ring that is attached to an air conduit leg 152 in the known region 157 thereof at an interior tangent region 147 of the ring, as shown in FIG. 8. FIG. 9 shows an alternative aspect of a leg retainer-engaging structure 162-2 in which a solid ring is connected to the leg 152 in the known region thereof by spokes 169. Regardless of the implementation of the leg retainer-engaging structure 162-1, 162-2, a complimentarily shaped leg retainer structure 142-2 is illustrated in FIGS. 4, 5 in the form of a split-ring having a split-opening 143-2. The split-opening 143-2 is sized to allow passage of the leg. The diameter of the split ring is sized so that the leg retainer structure 162 can concentrically slide inside the split ring. Thus the split opening provides an initial alignment for the leg, which can then be nominally raised or lowered to concentrically engage the solid ring 162 with the split ring 142-2. As before, the split ring opening can be oriented to face in any desired direction to facilitate entry of the leg and, when the solid ring and the split ring are concentrically engaged, the air inlet of the leg will be aligned for connection with the air outlet.

FIG. 7 shows a split-ring style leg retainer 142-2 having interior lip sections 146 that may be located at the top or the bottom of the split-ring. If located at the bottom of the split-ring, for example, the leg retainer-engaging structure 162-1, 162-2 will be disposed above the leg retainer structure 142-2 as the leg is introduced to or removed from the split-opening and then lowered into place for engagement or lifted out of place for dis-engagement. The operation is simply reversed if the lip sections 146 are located at the top of the split-ring. The lip 146 may be in sections as shown in FIG. 7 or may be partially or wholly continuous about the interior of the split-ring.

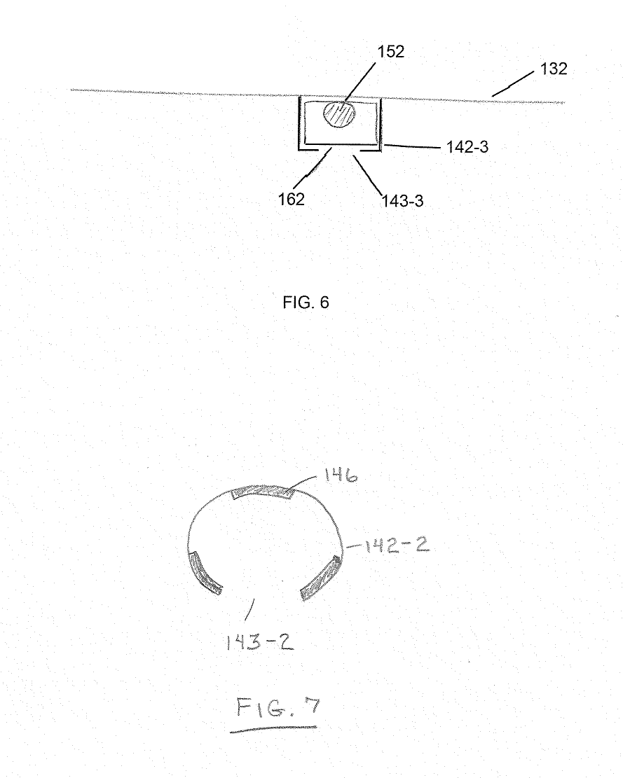

FIG. 6 shows another exemplary aspect of a leg retainer structure 142-3 and a complimentary leg retainer-engaging structure 162 similar to that shown in FIG. 8, but with a square shape rather than circular. Any convenient shape that is suitable to perform the intended function may be used.

In various non-limiting aspects, the size, shape, and configuration of the apparatus 100 or its component parts can be made to accommodate a particular situation of use and/or manufacturing. As examples, float pods may be circular with a 48 inch diameter so that two units may conveniently fit in the bed of a standard pick-up truck; the apparatus may have N=2, 4, 6, 8, . . . legs symmetrically distributed about the float pod; one, two, or more fine bubble diffusers may be attached to each leg output end, the apparatus may include a bio-media 198 as shown in FIG. 10, and so on.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. No language in the specification should be construed as indicating any non-claimed element as essential to the practice of the invention.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A wastewater aeration apparatus for use in a wastewater treatment lagoon, comprising:
a buoyant float pod including a float pod body having an air supply inlet and at least one air supply outlet, a plurality of first support members connected to and extending downward from the float pod body in spaced relation thereto, a horizontally-oriented support member connected at a distal end of each of the plurality of the first support members; and at least one leg-retainer structure connected to the horizontally-oriented support member;
at least one air conduit leg removably attached at a leg input end to a respective the at least one air supply outlet and having an air-outlet end, wherein the at least one leg has a known region at a fixed distance from the leg input end and intermediate the leg input end and the air-outlet end where the leg is removably engaged with a respective the at least one leg-retaining structure.

2. The wastewater aeration apparatus of claim 1, wherein the leg-retainer structure is a resilient clamp having an open end for removably engaging the known region of the leg.

3. The wastewater aeration apparatus of claim 2, wherein the resilient clamp has a detent region for removably engaging the known region of the leg.

4. The wastewater aeration apparatus of claim 2, wherein the open end of the resilient clamp is oriented in a direction tangent to a surface of the horizontal support structure.

5. The wastewater aeration apparatus of claim 1, further comprising a leg retainer-engaging structure connected to and surrounding the known region of the at least one leg, wherein the leg-retainer structure is a non-resilient split-ring having a given shape and dimension and oriented such that the split region is oriented vertically and disposed away from the horizontally-oriented support member at the point of attachment, further wherein the split has a dimension sufficient for the leg to pass through, and further wherein the leg-retainer structure and the leg retainer-engaging structure have complimentary shapes and dimensions that provide a removable, concentric engagement of the leg retainer-engaging structure with the leg-retainer structure, further wherein the leg input end and the respective air supply outlet are in alignment when the leg retainer-engaging structure is concentrically engaged within the leg-retainer structure.

6. The wastewater aeration apparatus of claim 5, wherein the split-ring leg retainer structure has a circular C-shape and the leg retainer-engaging structure is circular.

7. The wastewater aeration apparatus of claim 5, wherein the split-ring leg retainer structure has a squared C-shape and the leg retainer-engaging structure is square.

8. The wastewater aeration apparatus of claim 5, wherein the split-ring leg retainer structure has an interior lip on one of a top and a bottom surface thereof that prevents the leg retainer-engaging structure from passing completely through the split-ring leg retainer structure.

9. The wastewater aeration apparatus of claim 5, wherein the leg retainer-engaging structure is attached to the known region of the at least one leg at an interior tangent region of the leg-retainer-engaging structure.

10. The wastewater aeration apparatus of claim 1, wherein the air-outlet end of the at least one leg is disposed along a horizontal axis that is substantially normal to the horizontally-oriented support member where the known region of the leg engages the leg-retainer structure.

11. The wastewater aeration apparatus of claim 1, further comprising at least one fine-bubble diffuser removable attached to the air-outlet end of the at least one leg.

12. The wastewater aeration apparatus of claim 11, comprising one to six fine-bubble diffusers removable attached to the air-outlet end of the at least one leg.

13. The wastewater aeration apparatus of claim 1, comprising one to eight legs.

14. The wastewater aeration apparatus of claim 1, further comprising a supply of bio-media connected to a submergible region of the apparatus above the air-outlet end of the at least one leg.

15. The wastewater aeration apparatus of claim 1, wherein the at least one leg is extendable between the known region and the air-outlet end.

16. The wastewater aeration apparatus of claim 1, further comprising at least one counterweight removably connected to the at least one leg.

17. A method for servicing a portable wastewater aeration apparatus without removing the apparatus from a working environment thereof, comprising:
dispatching a person in a surface vessel to a floating wastewater aeration apparatus in a wastewater treatment lagoon, wherein the floating wastewater aeration apparatus includes a float pod body on the surface of the wastewater treatment lagoon and at least one air conduit leg having a leg input end attached to a respective air supply outlet on the float pod body and having an air-outlet end connected to a submerged bubble diffuser near the bottom of the lagoon;
from the surface vessel, detaching the input end of the at least one air conduit leg from the respective air supply outlet and disengaging a submerged region of the at least one air conduit leg from a submerged support structure of the apparatus; and
removing the at least one air conduit leg from the wastewater treatment lagoon.

18. The method of claim 17, further comprising:
servicing the bubble diffuser in the surface vessel;
re-engaging the at least one air conduit leg with the submerged support structure from the surface vessel; and
re-attaching the input end of the at least one air conduit leg from the respective air supply from the surface vessel.

19. The method of claim 18, wherein the step of servicing the bubble diffuser in the surface vessel includes connecting at least one fine-bubble diffuser to the air-outlet end of the air conduit leg.
